(19) United States
(12) Patent Application Publication
(10) Pub. No.: US 2008/0205417 A1
(43) Pub. Date: Aug. 28, 2008

(54) Method and apparatus for bridging wired and wireless communication networks

(76) Inventor: Huamin Li, San Diego, CA (US)

Correspondence Address: MORRISON & FOERSTER LLP, 755 PAGE MILL RD, PALO ALTO, CA, 94304-1018, US

(21) Appl. No.: 11/711,417

(22) Filed: Feb. 26, 2007

(51) Int. Cl. H04L 12/46

(52) U.S. Cl. 370/401

(57) ABSTRACT

Method and apparatus for bridging wired and wireless communication networks are disclosed. The method includes interfacing with a wired communication network, and interfacing with a wireless communication network, where the wired communication network and the wireless communication network have different communication media for transmitting communication signals, and the wired communication network and the wireless communication network use different communication protocols for transmitting the communication signals. The method further includes detecting the different communication protocols of the communication signals, programming a baseband processing module for transmitting the communication signals between the different communication protocols and the different communication media dynamically, and bridging communication signals between the wired communication network and the wireless communication network using the baseband processing module.

### FIELD OF THE INVENTION

The present invention relates to the field of communication networks. In particular, the present invention relates to a method and apparatus for bridging wired and wireless communication networks.

### BACKGROUND OF THE INVENTION

In recent years, mobile devices, such as cellular phones and portable personal digital assistances (PDAs), have been widely adopted to assist people to communicate with each other while they are traveling. There are various protocols based on OFDM or a variation of OFDM used for communication of information among users. For example, there are WiFi, WiMAX, DVB-T/H/S, DMB for wireless communication networks and digital subscriber line (DSL), Power line, DOCSIS for wired communication networks. The advantage of OFDM based protocol is that the signal is resilient in a multi-path environment such as in a mobile communication situation or an urban environment. However, the wired communication network and wireless communication network are not interoperable because of the different communication media and because of the different communication protocols used in transmitting and receiving communication signals in the wired and wireless communication networks. In other words, if one device uses one communication medium such as the cable line and another device uses another communication medium such as the satellite, these two devices can not communicate with each other from the cable line to the satellite or vice versa. Similarly, if one device uses one communication protocol such as the DOCSIS and another device uses another communication protocol such as the WiMAX, these two devices can not communicate with each other because of the differences in the communication protocols used by the two devices.

To address this problem, conventional methods build dedicated hardware and software systems to bridge one specific medium to another specific medium, such as from the phone line to the satellite transmission of cellular signals for cellular phones. The conventional methods also implement dedicated hardware and software systems to communicate between specific protocols, such as from DOCSIS to WiMAX. However, because such systems rely on dedicated hardware and software implementations to provide point-to-point solutions, they are not scalable to cover new communication media or new communication protocols. As a result, such conventional systems may not work for both North America and Asia because of the different communication media and protocols used in the two different regions.

Therefore, there is a need for a method and apparatus that can bridge between wired and wireless communication networks for multiple communication media and multiple communication protocols.

### SUMMARY

The present invention relates to a method and apparatus for bridging wired and wireless communication networks. The invention supports data communications between multiple communication media, multiple communication protocols, and multiple system interfaces. This is accomplished by using a reconfigurable and processing sharing technique that extracts variations of protocol, medium, and interface processing into a reconfiguration baseband processing module, and using an intelligent controller to dynamically configure the baseband processing module in accordance with the requirements of the incoming and outgoing communication signals in the wired and wireless communication networks.

In one embodiment, an apparatus for bridging wired and wireless communication networks includes a first network interface configured to interface with a wired communication network, and a second network interface configured to interface with a wireless communication network, where the wired communication network and the wireless communication network have different communication media for transmitting communication signals and the wired communication network and the wireless communication network use different communication protocols for transmitting the communication signals. The apparatus further includes a baseband processing module configured to bridge communication signals between the first network interface and the second network interface, and a controller configured to detect the different communication protocols of the communication signals and to program the baseband processing module dynamically for transmitting the communication signals between the different communication protocols and the different communication media.

In another embodiment, a method for bridging wired and wireless communication networks includes interfacing with a wired communication network, and interfacing with a wireless communication network, where the wired communication network and the wireless communication network have different communication media for transmitting communication signals, and the wired communication network and the wireless communication network use different communication protocols for transmitting the communication signals. The method further includes detecting the different communication protocols of the communication signals, programming a baseband processing module for transmitting the communication signals between the different communication protocols and the different communication media dynamically, and bridging communication signals between the wired communication network and the wireless communication network using the baseband processing module.

### BRIEF DESCRIPTION OF THE DRAWINGS

The aforementioned features and advantages of the invention, as well as additional features and advantages thereof, will be more clearly understandable after reading detailed descriptions of embodiments of the invention in conjunction with the following drawings.

FIG. 1 illustrates an application of the wire-wireless bridge device according to an embodiment of the present invention.

FIG. 2 illustrates a block diagram of the wire-wireless bridge device according to an embodiment of the present invention.

FIG. 3 illustrates interactions between the controller and the baseband processing module of the wire-wireless bridge device according to an embodiment of the present invention.

FIG. 4 illustrates a block diagram of the baseband processing module of the wire-wireless bridge device according to an embodiment of the present invention.

FIG. 5 illustrates a block diagram of the controller of the wire-wireless bridge device according to an embodiment of the present invention.

FIG. 6 illustrates a flow diagram for the controller of the wire-wireless bridge device according to an embodiment of the present invention.

FIG. 7 illustrates an application of the wire-wireless bridge device according to an embodiment of the present invention.

FIG. 8 illustrates another application of the wire-wireless bridge device according to an embodiment of the present invention.

FIG. 9 illustrates yet another application of the wire-wireless bridge device according to an embodiment of the present invention.

FIG. 10 illustrates yet another application of the wire-wireless bridge device according to an embodiment of the present invention.

FIG. 11 illustrates yet another application of the wire-wireless bridge device according to an embodiment of the present invention.

Like numbers are used throughout the figures.

### DESCRIPTION OF EMBODIMENTS

Method and apparatus are provided for bridging wired and wireless communication networks. The following descriptions are presented to enable any person skilled in the art to make and use the invention. Descriptions of specific embodiments and applications are provided only as examples. Various modifications and combinations of the examples described herein will be readily apparent to those skilled in the art, and the general principles defined herein may be applied to other examples and applications without departing from the spirit and scope of the invention. Thus, the present invention is not intended to be limited to the examples described and shown, but is to be accorded the widest scope consistent with the principles and features disclosed herein.

Some portions of the detailed description that follows are presented in terms of flowcharts, logic blocks, and other symbolic representations of operations on information that can be performed on a computer system. A procedure, computer-executed step, logic block, process, etc., is here conceived to be a self-consistent sequence of one or more steps or instructions leading to a desired result. The steps are those utilizing physical manipulations of physical quantities. These quantities can take the form of electrical, magnetic, or radio signals capable of being stored, transferred, combined, compared, and otherwise manipulated in a computer system. These signals may be referred to at times as bits, values, elements, symbols, characters, terms, numbers, or the like. Each step may be performed by hardware, software, firmware, or combinations thereof.

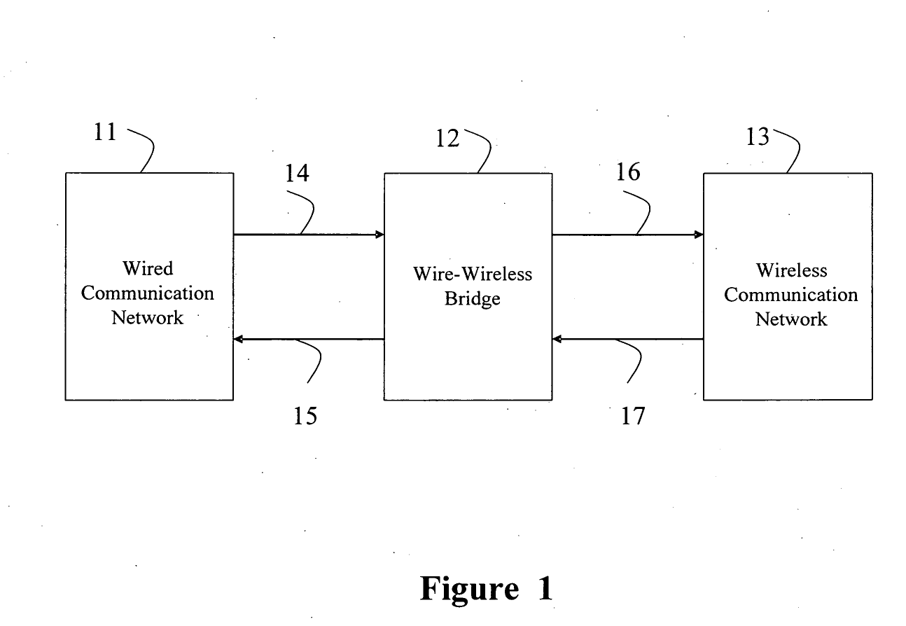

FIG. 1 illustrates an application of the wire-wireless bridge device according to an embodiment of the present invention. As shown in FIG. 1, a wire-wireless bridge 12 is used to communicate between a wired communication network 11 and a wireless communication network 12. In this example, a communication from the wired communication network 111 to the wireless communication network 13 may be conducted as follows. A first incoming communication signal is received through one or more wired communication means 14. After the first incoming communication signal is received and processed by the wire-wireless bridge 12, it is transmitted to the wireless communication network through one or more wireless communication means 16 to the wireless communication network 13. Similarly, a communication from the wireless communication network 13 to the wired communication network 11 may be conducted as follows. A second incoming communication signal is received through one or more wireless communication means 17. After the second incoming communication signal is received and processed by the wire-wireless bridge 12, it is transmitted to the wireless communication network through one or more wired communication means 15 to the wired communication network 11.

Note that in different embodiments of the present invention, the one or more wired communication means 14 and 15 may share the same medium or may use different media, such as digital subscriber line (DSL), Ethernet, cable, phone line, or power line. In addition, the one or more wireless communication means 16 and 17 may share the same medium or may use different media, such as satellite or terrestrial transmission.

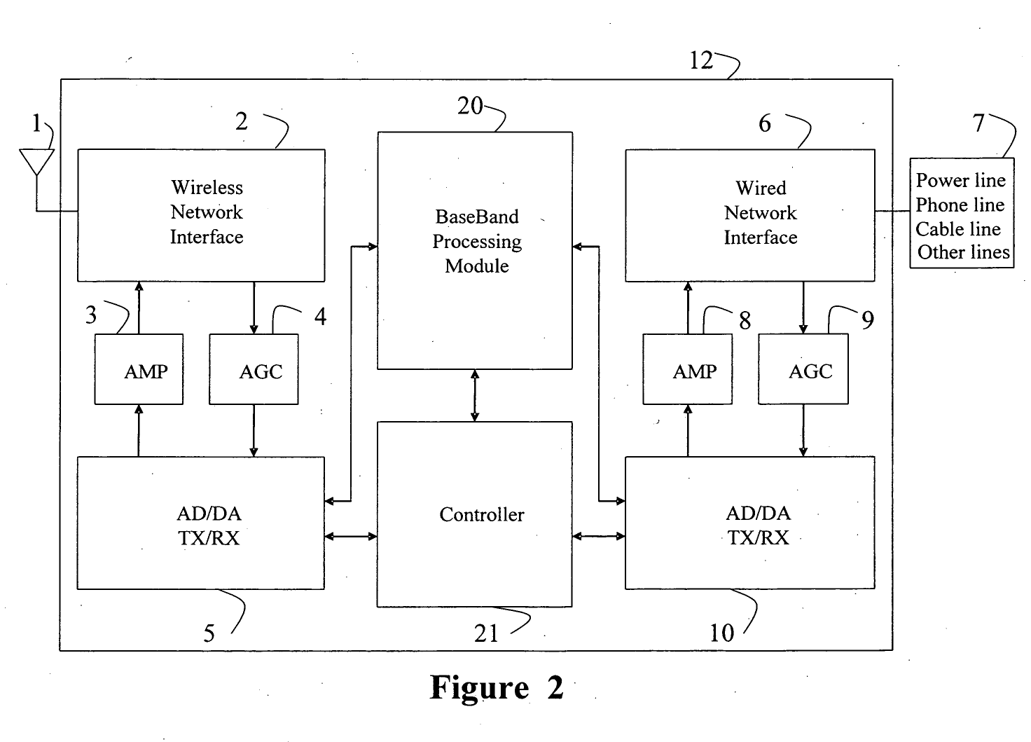

FIG. 2 illustrates a block diagram of the wire-wireless bridge device according to an embodiment of the present invention. In the example shown in FIG. 2, the wire-wireless bridge device includes a baseband processing module 20 and a controller unit 21. In addition, on the wireless network communication side, the wire-wireless bridge device includes a wireless network interface 2, an amplifier (AMP) 3, an automatic gain control unit (AGC) 4, and an analog-to-digital/digital-to-analog (AD/DA) converter or transmitter-receiver (TX/RX) 5. On the wired communication network side, the wire-wireless bridge device further includes a wired network interface 6, an amplifier (AMP) 8, an automatic gain control unit (AGC) 9, and an analog-to-digital/digital-to-analog (AD/DA) converter or transmitter/receiver (TX/RX) 10.

The wireless network interface 2 receives and transmits wireless signals from and to multiple wireless sources through wireless media represented by the numeral 1. Similarly, the wired network interface 6 receives and transmits wired signals from and to multiple wired sources through wired media represented by the numeral 7.

For example, the wire-wireless bridge device 12 may be configured to receive signals encoded in multiple wired protocols. First, a communication signal from a wired network is received by the wired network interface 6, which delivers the signal to the AD/DA converter 5 via the AGC 9. The AGC 9 controls the gain of the wire-wireless bridge device in order to maintain adequate performance over a range of input signal levels. Next, the AD/DA converter 5 delivers a converted digital signal to the baseband processing module 20 and to the controller 21. The controller 21 analyzes the incoming signal to determine the communication protocol of the incoming signal. The controller retrieves a set of configuration parameters and binary codes for configuring the baseband processing module 20 in accordance with the communication protocol of the incoming signal. The controller 21 configures the baseband processing module 20 using the set of configuration parameters and binary codes. Next, after the baseband processing module 20 is configured, it processes the incoming digital signal using one or more of the predetermined communication protocols, for example FFT, channel decode, de-framing, and error correction, to decode the received data content form the incoming signal. Afterwards, the decoded data content is delivered to the high level (MAC layer 32) to be further processed to obtain the application data, which is also referred to as the application payload, for further processing by the application layer above.

For another example, the wire-wireless bridge device 12 may be configured to transmit signals encoded in multiple wireless protocols. First, the media access control (MAC) layer of the software application 32 receives and processes an application payload, and creates communication packets for transmission. The communication packets are then delivered to the baseband processing module 20. Next, the controller 21 is notified by MAC layer 32 that a new protocol is to be processed in the baseband processing module 20. The controller then retrieves a corresponding set of configuration parameters and binary codes for the new protocol, and configures the baseband processing module 20 using the set of configuration parameters and binary codes. Then, after the baseband processing module 20 being configured by the controller, it processes the incoming digital signal using one or more of the predetermined OFDM based communication protocols, such as channel encode, framing, IFFT to decode the received baseband signal to be sent to the AD/DA converter 5. Afterwards, the AD/DA converter 5 delivers a converted analog signal to the wireless network interface 2 via an amplifier 3. The wireless network interface 2 modulates the signal to proper carrier frequency and transmits it over antenna to a wireless communication network.

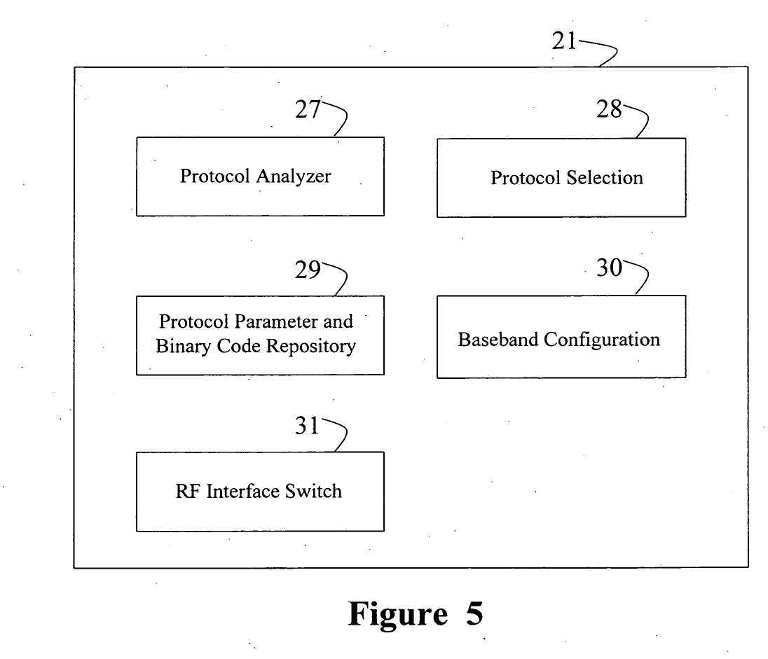

For yet another example, the wire-wireless bridge device 12 may be configured to bridge between multiple communication protocols between the wired communication network 11 and the wireless communication network 13. In this case the device of FIG. 5 is used to bridge two protocols. In other words, the protocol coming from the wired interface may be converted to the wireless protocol. First, the method for receiving signals encoded in multiple wired protocols described above is repeated to obtain the application payload of the incoming signal at the MAC layer 22. Next, the result of MAC layer 32, instead of delivered to a software application at a higher layer, is again processed at the MAC layer according to the outbound protocol. The processed data is then delivered to the baseband processing module 20. The controller 21 is notified by MAC layer 32 that a new processing protocol is to be performed at the baseband processing module 20. The controller retrieves a set of configuration parameters and binary codes for the new protocol and configures the baseband processing module 20 using the set of configuration parameters and binary codes accordingly. After the baseband processing module 20 being configured by the controller 21, it processes the digital signal using one or more of the predetermined OFDM based communication protocols, such as channel encode, framing, IFFT to decode the baseband signal to be sent to the AD/DA converter 5. Afterwards, the AD/DA converter 5 delivers a converted analog signal to the wireless network interface 2 via an amplifier 3. The wireless network interface 2 modulates the signal to proper carrier frequency and transmits it over antenna to a wireless communication network.

Note that in order to handle multiple communication protocols and multiple communication media for both the wired and wireless communication networks, the controller 21 is capable of dynamically configuring the baseband processing module 20 of the wire-wireless bridge device according to the protocols and media of the communication signals received and transmitted.

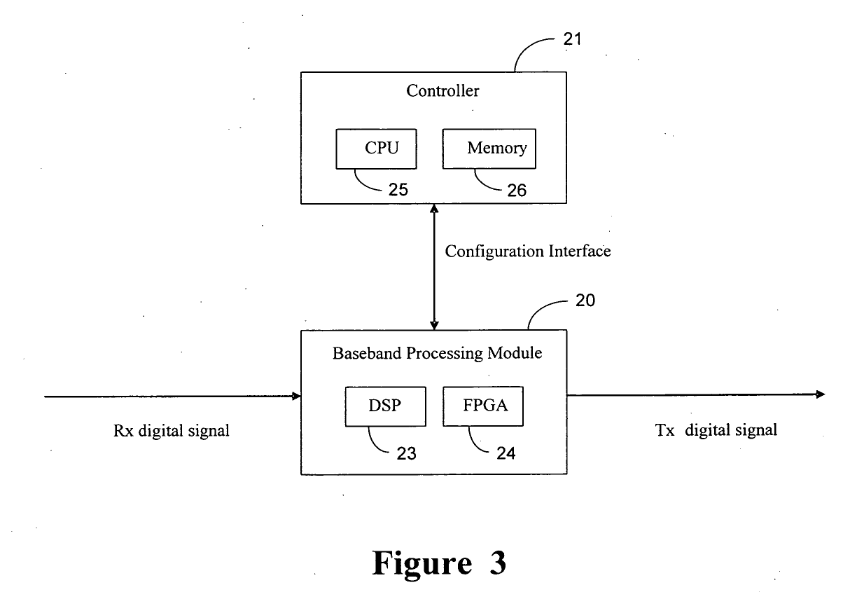

FIG. 3 illustrates an implementation of the controller and the baseband processing module of the wire-wireless bridge device according to an embodiment of the present invention. In various embodiments of the present invention, transactions between the baseband processing module 20 and the controller 20 may implement a standardized interface so that any implementation of the baseband processing module and the controller that comply with the standard interface may work with each other. In one implementation, the baseband processing module 20 may be implemented with a combination of digital signal processor (DSP) 23 and a field programmable gate array (FPGA) 24. The controller 21 may be implemented with a 32-bit central processing unit (CPU) 25 and a memory storage device 26.

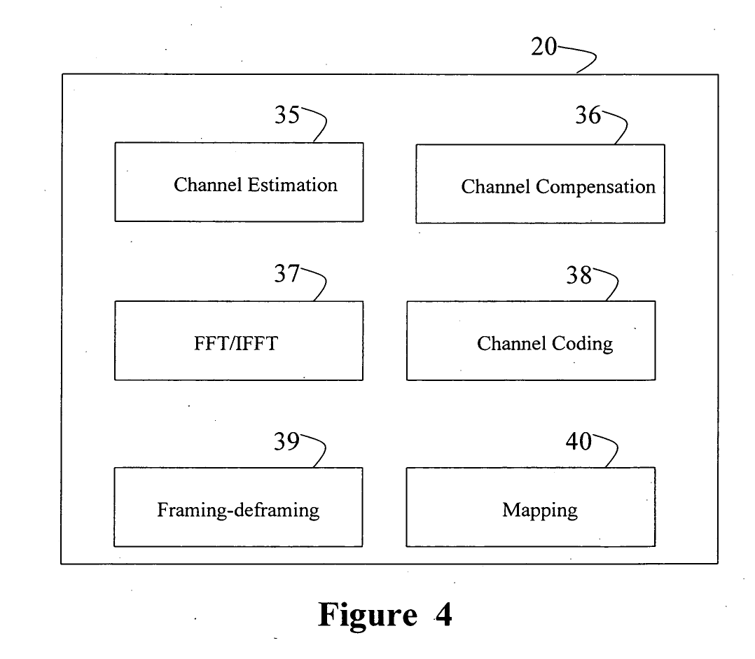

FIG. 4 illustrates a block diagram of the baseband processing module of the wire-wireless bridge device according to an embodiment of the present invention. As described above, the baseband processing module 20 may be configured and/or reconfigured with programmable parameters and/or binary codes to handle any specific communication protocols and media. When a new protocol is to be processed at baseband level, programmable parameters corresponding to the new protocol are set by the controller 21. Proper binary codes are downloaded to the baseband processing module 20 if necessary. After the configuration process, the baseband processing module 20 may process the new protocol.

As shown in FIG. 4, the baseband processing module 20 includes a channel estimation module 35, a channel compensation module 36, a fast Fourier transform (FFT/IFFT) module 37, a channel coding module 38, a framing-deframing module 39, and a mapping module 40 in various embodiments of the present invention. The channel estimation module 35 estimates the noise level and distortion level of the communication media through which the signal travels. The channel compensation module 36 compensates the received signal (in terms of amplitude and phase of the sampled analog signal) according to the outcome of the channel estimation previously performed. The FFT/IFFT module 37 converts signals between frequency domain and time domain, which may be required by the OFDM-based communication protocols. The channel coding module 38 encodes/decodes the baseband signals (in terms of bits) so that if any bit error occurs due to a noisy environment, it can be corrected. The channel coding module 38 implements one or more channel coding algorithms, such as interleaving, forward error correction (Viterbi, Turbo, Reed Solomon, etc.). The framing-deframing module 39 partitions a continuous bit stream into frames and insert markers or pilots into each frame for channel estimation and for other purposes during transmission of a communication signal. In addition, the framing-deframing module 39 removes previously inserted markers or pilots, and reassembles the frames back to a continuous bit stream during receiving of the communication signal. The mapping module 40 maps groups of bits, for example a group of 4 bits, into symbols as defined by a modulation technique (e.g. QAM16).

Note that each module in the baseband processing module 20 may be configured with parameters as required by a specific protocol. For example, when 802.11a protocol is selected, the FFT/IFFT module 37 may be configured as a 64-point FFT/IFFT; when WiMAX protocol is selected, the FFT/IFFT module 37 may be configured as a 256-point FFT/IFFT. Moreover, when the Reed-Solomon algorithm is employed for channel coding, there are two parameters that need to be configured: 1) the number of total symbols (n), including both data symbols and error correction symbols, per coding block, and 2) the number of data symbols per block (k). These two parameters may vary depending on the specific communication protocol of the signal to be processed. When a protocol is selected, the controller 21 configures the channel coding module to perform the Reed-Solomon algorithm with proper parameters n and k. Furthermore, the framing and deframing module 39 is also configured by the controller 21 with parameters such as pilot size, preamble size, etc. according to the different communication protocols being implemented.

In addition to configuring the parameters of a module, binary codes of the module may be replaced for processing new protocols in alternative implementations. Binary codes (or microcodes) are the instruction set that provide instructions to a module. This is done by downloading new binary codes to the module corresponding to a new communication protocol to be implemented. In some cases, this may be accomplished by configuring parameters of a module. In some other cases, this may be accomplished by downloading new binary codes to configure the module.

FIG. 5 illustrates a block diagram of the controller of the wire-wireless bridge device according to an embodiment of the present invention. In the example shown in FIG. 5, the controller 21 includes a protocol analyzer module 27, a signal protocol selection module 28, a protocol parameter and binary code repository module, a baseband configuration module 30, and a radio-frequency (RF) interface switch module 31. The protocol analyzer module 27 receives signals from multiple RF interfaces and analyzes the received signals to determine a corresponding communication protocol to be implemented. The signal protocol selection module 28 selects a protocol to be implemented by one of the two inputs: 1) obtain an interactive command from a user (for example, a user may press a button “802.11a”, which means that the 802.11a protocol is selected); or 2) obtain a command from the protocol analyzer 27. The protocol parameter and binary code repository module 29 store the configuration parameters and binary codes to be used for the baseband processing module 20. The baseband configuration module 30 configures the baseband processing module 20 with proper parameters and binary codes based on a protocol selected by the signal protocol selection module 28. The RF interface switch module 31 connects one of the multiple RF interfaces with the baseband processing module 20.

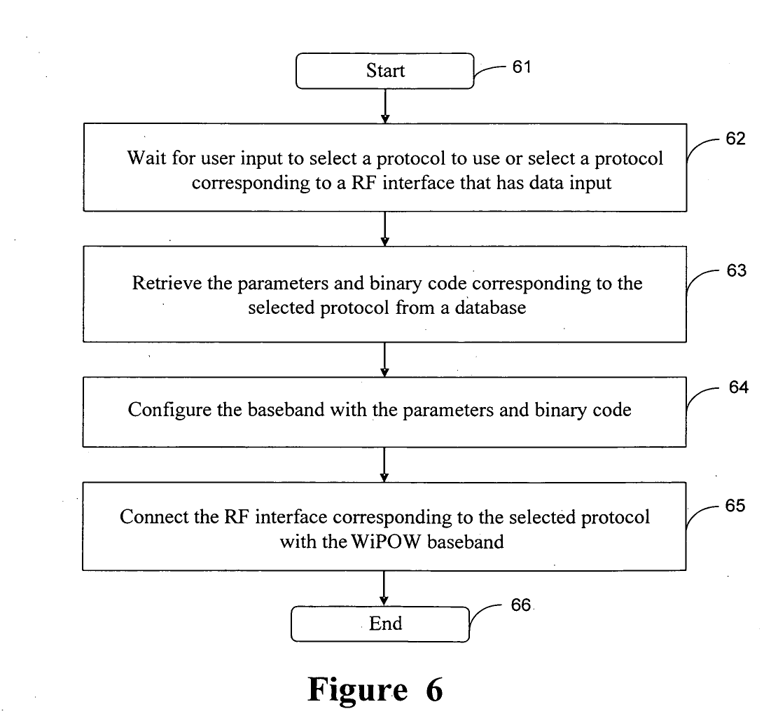

FIG. 6 illustrates a flow diagram for the controller of the wire-wireless bridge device according to an embodiment of the present invention. The method starts in block 61 and thereinafter moves to block 62. In block 62, the controller waits for a user input to select a protocol or select a protocol corresponding to an RF interface that has a data input. In step 63, the controller retrieves the parameters and binary codes corresponding to the selected protocol from a database. In block 64, the controller configures the baseband processing module using the parameters and binary codes retrieved. In block 65, the controller connects the RF interface corresponding to the selected protocol with the baseband processing module. After block 65, the baseband processing module is ready to process the selected protocol. The method ends in block 66.

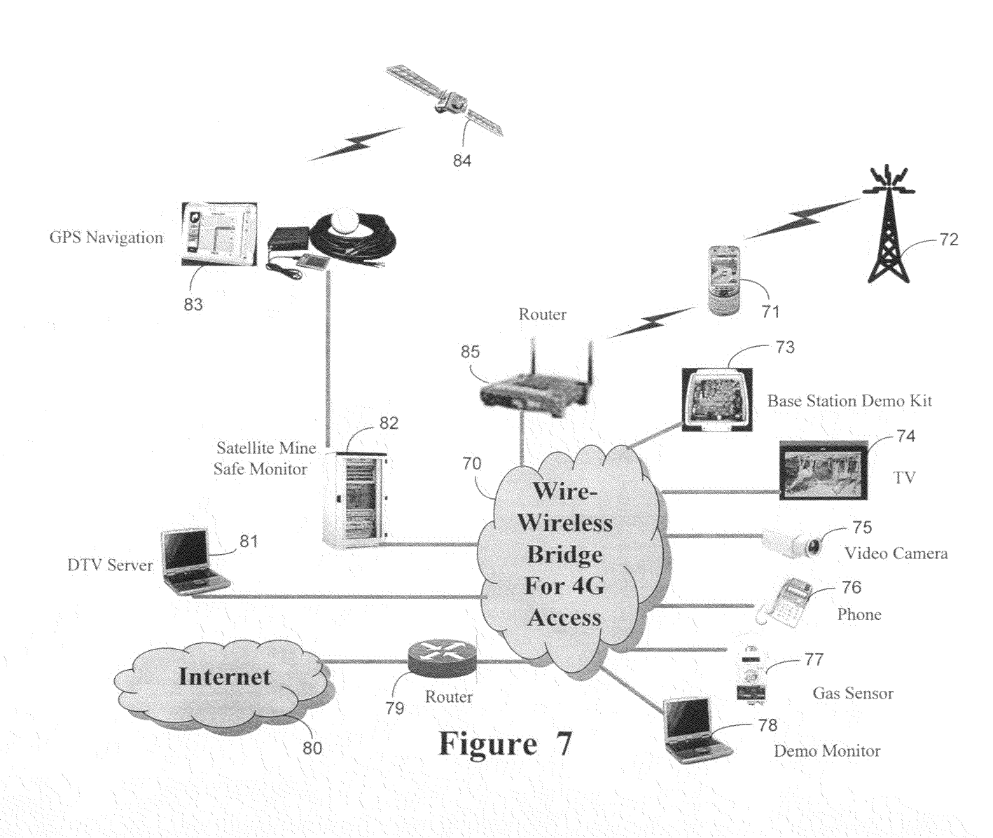

FIG. 7 illustrates an application of the wire-wireless bridge device according to an embodiment of the present invention. As shown in FIG. 7, the system includes a wire-wireless bridge 70 as a central hub for communication with various wired and wireless communication devices implementing the fourth generation wireless communication technology. The system further includes connections to a router 85, a cellular phone 71, a cellular tower 72, a base station demonstration kit 73, a television 74, a video camera 75, a land line phone 76, a gas sensor 77, a laptop computer as a demonstration monitor, a router 79 that connects to the Internet 80, a digital TV server 81, a server 82 for monitoring mine safety, and a GPS navigation system 83 that communicates with a satellite 84.

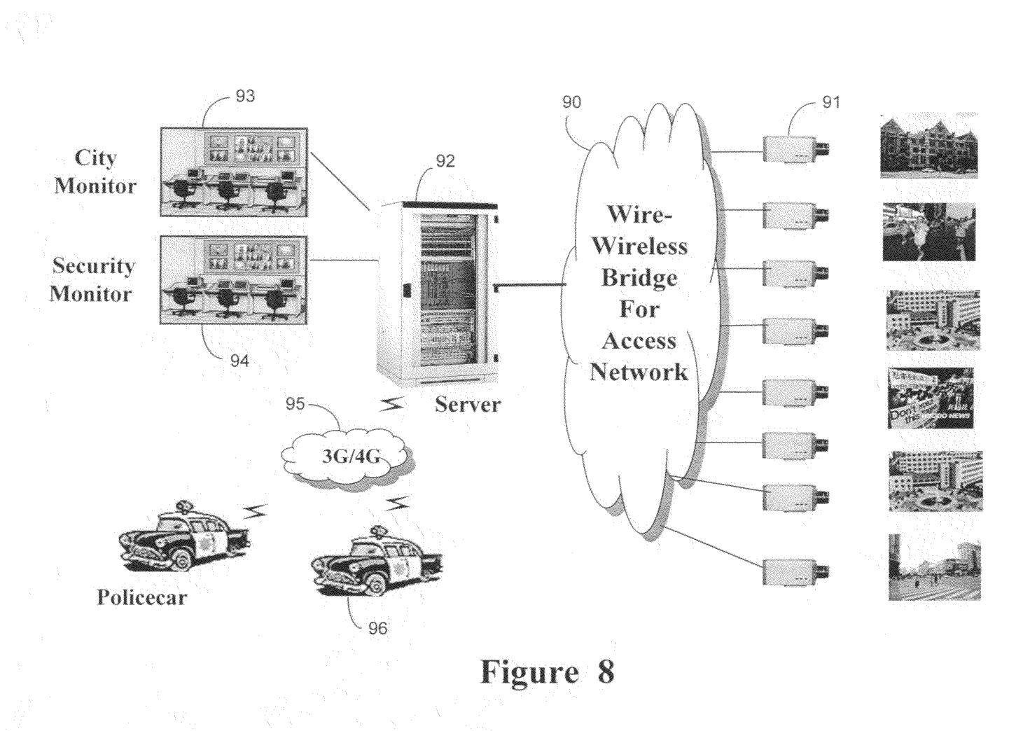

FIG. 8 illustrates another application of the wire-wireless bridge device according to an embodiment of the present invention. In this example, the system includes a wire-wireless bridge 90 as a central hub for communication with various wired and wireless communication devices in a security application. The system further includes multiple video cameras for monitoring various locations and activities, a server 92 that communicates with a city monitoring center 93 and a security monitoring center 94, and the server also communicates with police cars 96 via 3G/4G wireless communication technologies 95.

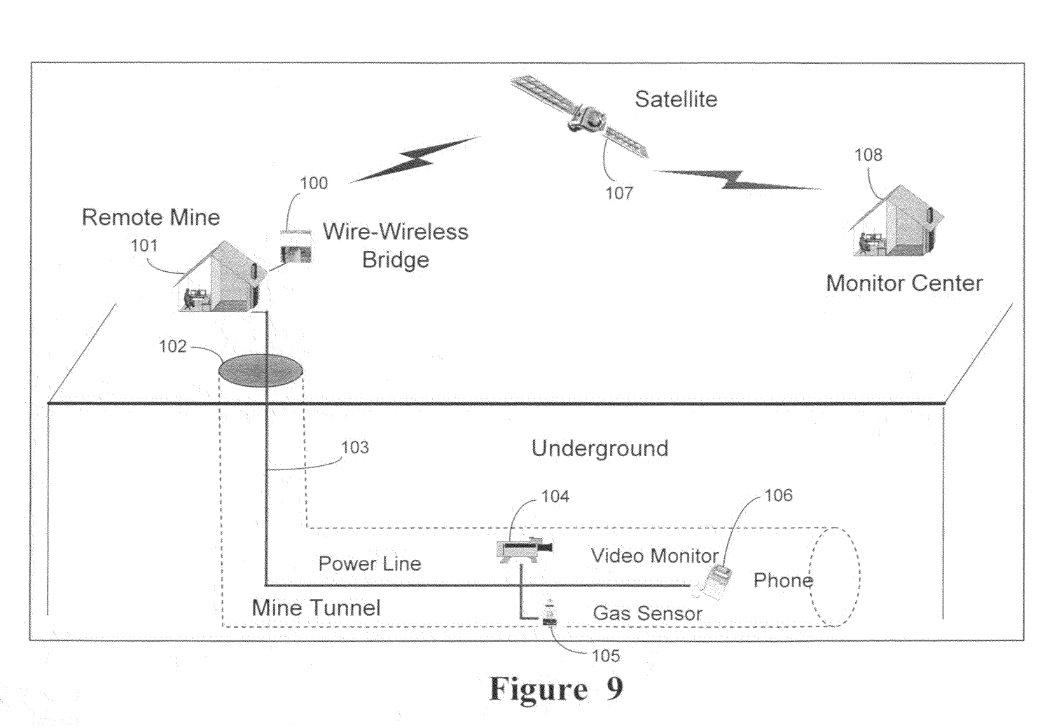

FIG. 9 illustrates yet another application of the wire-wireless bridge device according to an embodiment of the present invention. In the example shown in FIG. 9, the system includes a wire-wireless bridge 100 as a central hub for communication with various wired and wireless communication devices in a mine safety monitoring application. The system further includes a remote mine office 101, a mine tunnel 102, a power line 103, an underground video monitor 104, a gas sensor 105, and a phone 106. The wire-wireless bridge communicates conditions in the mine tunnel to a monitor center 108 via a satellite 107.

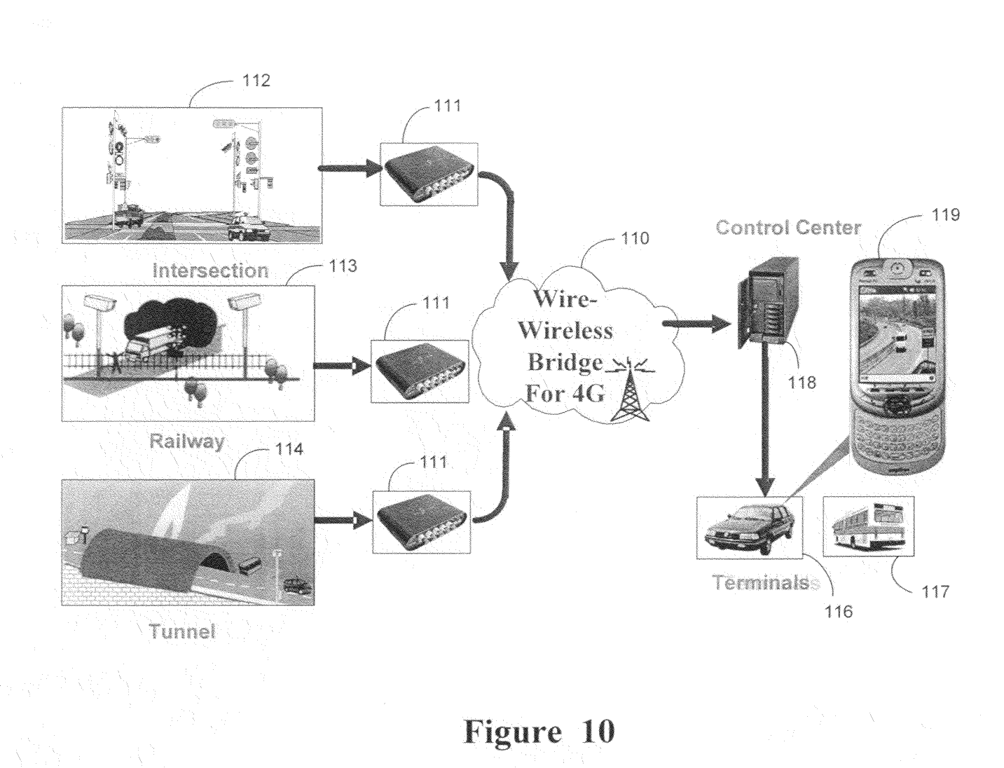

FIG. 10 illustrates yet another application of the wire-wireless bridge device according to an embodiment of the present invention. As shown in FIG. 10, the system includes a wire-wireless bridge 110 as a central hub for communication with various wired and wireless communication devices in a traffic monitoring application. The systems further includes multiple routers that directs traffic information from street intersections 112, from railway crossings 113, and from tunnels 114, a server 118 in a control center that transmits the traffic information to various receiver terminals, such as a car 116 and a bus 117. A user in the car is able to view a picture of a particular traffic location of her interest using her cellular phone 119.

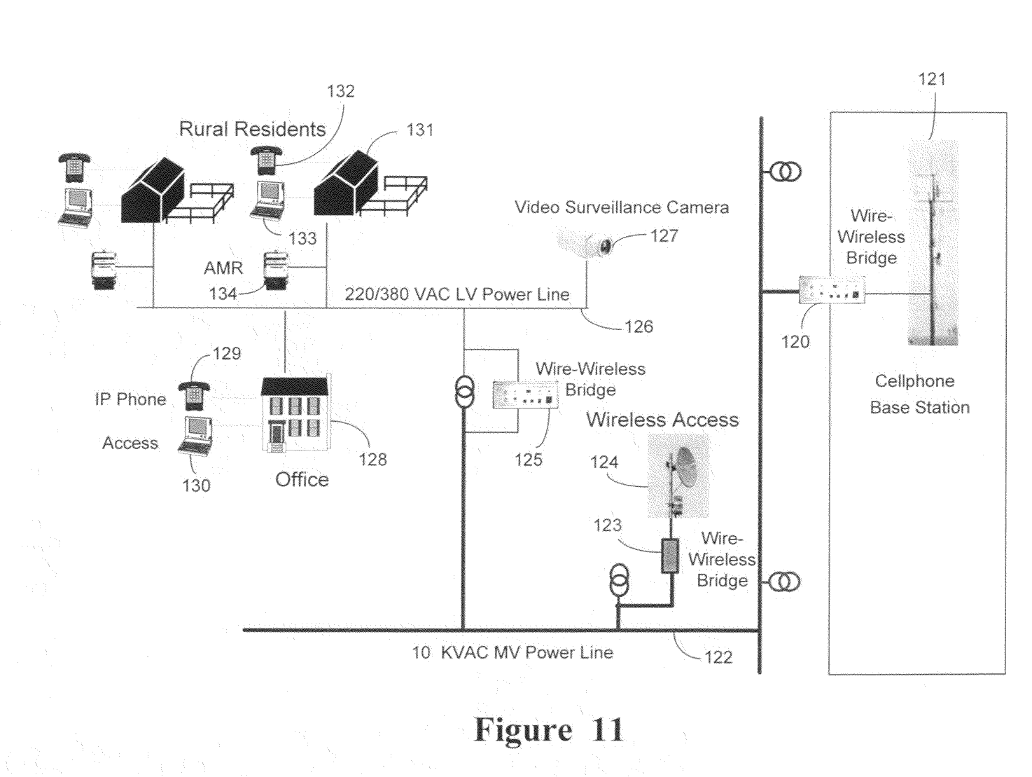

FIG. 11 illustrates yet another application of the wire-wireless bridge device according to an embodiment of the present invention. In this example, the system includes multiple wire-wireless bridges 120, 123, and 125 as means for communication with various wired and wireless communication devices using power lines. The system further includes a cellular phone base station 121, a 10 KVAC MV power line 122, a satellite dish 124, a 220/380 VAC LV power line 126, a video surveillance camera 127, multiple rural houses 131 with each house having a phone 132, a personal computer 133, and an adaptive multi-rate (AMR) device coupled to the power line connecting to each of the houses.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processors or controllers. Hence, references to specific functional units are to be seen as references to suitable means for providing the described functionality rather than indicative of a strict logical or physical structure or organization.

The invention can be implemented in any suitable form, including hardware, software, firmware, or any combination of these. The invention may optionally be implemented partly as computer software running on one or more data processors and/or digital signal processors. The elements and components of an embodiment of the invention may be physically, functionally, and logically implemented in any suitable way. Indeed, the functionality may be implemented in a single unit, in a plurality of units, or as part of other functional units. As such, the invention may be implemented in a single unit or may be physically and functionally distributed between different units and processors.

One skilled in the relevant art will recognize that many possible modifications and combinations of the disclosed embodiments may be used, while still employing the same basic underlying mechanisms and methodologies. The foregoing description, for purposes of explanation, has been written with references to specific embodiments. However, the illustrative discussions above are not intended to be exhaustive or to limit the invention to the precise forms disclosed. Many modifications and variations are possible in view of the above teachings. The embodiments were chosen and described to explain the principles of the invention and their practical applications, and to enable others skilled in the art to best utilize the invention and various embodiments with various modifications as suited to the particular use contemplated.

What is claimed is:

1. An apparatus for bridging wired and wireless communication networks, comprising:
a first network interface configured to interface with a wired communication network;
a second network interface configured to interface with a wireless communication network, wherein the wired communication network and the wireless communication network have different communication media for transmitting communication signals, and wherein the wired communication network and the wireless communication network use different communication protocols for transmitting the communication signals;
a baseband processing module configured to bridge communication signals between the first network interface and the second network interface; and
a controller configured to detect the different communication protocols of the communication signals and to program the baseband processing module dynamically for transmitting the communication signals between the different communication protocols and the different communication media.

2. The apparatus of claim 1, wherein the baseband processing module comprises:
a channel estimation module configured to estimate noise level and distortion level of the communication media; and
a channel compensation module configured to compensate the communication signals according to information gathered by the channel estimation module.

3. The apparatus of claim 2, wherein the baseband processing module further comprises:
a fast Fourier transform module configured to convert signals between frequency domain and time domain; and
a channel coding module configured to implement one or more channel coding algorithms, wherein the one or more channel code algorithms include at least one of interleaving and forward error correction algorithms.

4. The apparatus of claim 3, wherein the baseband processing module further comprises:
a framing-deframing module configured to partition a continuous bit stream into frames during transmission and reassemble the frames back to the continuous bit stream during receiving of the communication signals; and
a mapping module configured to map groups of bits into symbols as defined by a modulation technique.

5. The apparatus of claim 1, wherein the controller comprises:
a protocol analyzer module configured to determine a communication protocol for receiving signals from one or more RF interfaces; and
a protocol selection module configured to select a protocol to be implemented by the baseband processing module.

6. The apparatus of claim 5, wherein the controller further comprises:
a repository database configured to store protocol parameters and binary codes of the different communication protocols; and
a baseband configuration module configured to program the baseband processing module using the protocol parameters and binary codes.

7. The apparatus of claim 6, wherein the controller further comprises:
a radio frequency (RF) interface switch module configured to connect the one or more RF interfaces with the baseband processing module.

8. The apparatus of claim 1, wherein the different communication media comprise:
wired media including at least one of digital subscriber line, phone line, cable, and power line; and
wireless media including at least one of satellite and terrestrial transmission.

9. The apparatus of claim 1, wherein the different communication protocols comprise:
wired communication protocol including at least one of DOCSIS, DVB-C; and
wireless communication protocol including at least one of OFDM, COFDM, DMT, WiFi, WiMAX, DVB-T/H/S, and DMB.

10. The apparatus of claim 1, wherein the first network interface comprises:
a wired network interface configured to interface with the wired communication network;
a first amplifier configured to amplify signals to be transmitted to the wired communication network;
a first automatic gain control module configured to maintain performance over a range of input signal levels; and
a first transmitter-receiver module configured to convert analog signals received from the wired communication network to digital signals to be processed by the baseband processing module and to convert digital signals received from the baseband processing module to analog signals to be transmitted to the wired communication network.

11. The apparatus of claim 1, wherein the second network interface comprises:
a wireless network interface configured to interface with the wireless communication network;
a second amplifier configured to amplify signals to be transmitted to the wireless communication network;
a second automatic gain control module configured to maintain performance over a range of input signal levels; and
a second transmitter-receiver module configured to convert analog signals received from the wireless communication network to digital signals to be processed by the baseband processing module and to convert digital signals received from the baseband processing module to analog signals to be transmitted to the wireless communication network.

12. A method for bridging wired and wireless communication networks, comprising:
interfacing with a wired communication network;
interfacing with a wireless communication network, wherein the wired communication network and the wireless communication network have different communication media for transmitting communication signals, and wherein the wired communication network and the wireless communication network use different communication protocols for transmitting the communication signals;
detecting the different communication protocols of the communication signals;
programming a baseband processing module for transmitting the communication signals between the different communication protocols and the different communication media dynamically; and
bridging communication signals between the wired communication network and the wireless communication network using the baseband processing module.

13. The method of claim 12, wherein detecting the different communication protocols comprises:
determining a communication protocol for receiving signals from one or more RF interfaces; and
selecting a protocol to be implemented by the baseband processing module.

14. The method of claim 13, wherein programming a baseband processing module comprises:
storing protocol parameters and binary codes of the different communication protocols; and
programming the baseband processing module using the protocol parameters and binary codes.

15. The method of claim 14, wherein programming a baseband processing module further comprises:
connecting the one or more RF interfaces with the baseband processing module.

16. The method of claim 12, wherein bridging communication signals between the wired communication network and the wireless communication network comprises:
estimating noise level and distortion level of the communication media; and
compensating the communication signals according to the noise level and distortion level of the communication media.

17. The method of claim 16, wherein bridging communication signals between the wired communication network and the wireless communication network further comprises:
converting signals between frequency domain and time domain; and
implementing one or more channel coding algorithms, wherein the one or more channel code algorithms include at least one of interleaving and forward error correction algorithms.

18. The method of claim 17, wherein bridging communication signals between the wired communication network and the wireless communication network further comprises:
partitioning a continuous bit stream into frames during transmission and reassembling the frames back to the continuous bit stream during receiving of the communication signals; and
mapping groups of bits into symbols as defined by a modulation technique.

19. The method of claim 12, wherein the different communication media comprise:
wired media including at least one of digital subscriber line, phone line, cable, and power line; and
wireless media including at least one of satellite and terrestrial transmission.

20. The method of claim 12, wherein the different communication protocols comprise:
wired communication protocol including at least one of DOCSIS, DVB-C; and
wireless communication protocol including at least one of OFDM, COFDM, DMT, WiFi, WiMAX, DVB-T/H/S, and DMB.

21. The method of claim 12, wherein interfacing with a wired communication network comprises:
providing a wired network interface configured to interface with the wired communication network;
providing a first amplifier configured to amplify signals to be transmitted to the wired communication network;
providing a first automatic gain control module configured to maintain performance over a range of input signal levels; and
providing a first transmitter-receiver module configured to convert analog signals received from the wired communication network to digital signals to be processed by the baseband processing module and to convert digital signals received from the baseband processing module to analog signals to be transmitted to the wired communication network.

22. The method of claim 12, wherein interfacing with a wireless communication network comprises:
providing a wireless network interface configured to interface with the wireless communication network;
providing a second amplifier configured to amplify signals to be transmitted to the wireless communication network;
providing a second automatic gain control module configured to maintain performance over a range of input signal levels; and
providing a second transmitter-receiver module configured to convert analog signals received from the wireless communication network to digital signals to be processed by the baseband processing module and to convert digital signals received from the baseband processing module to analog signals to be transmitted to the wireless communication network.
